(19) United States
(12) Patent Application Publication
(10) Pub. No.: US 2021/0408814 A1
(43) Pub. Date: Dec. 30, 2021

(54) INTELLIGENT CHARGING EQUIPMENT

(71) Applicant: HSU HAN, Taipei (TW)

(72) Inventor: HSU HAN, Taipei (TW)

(21) Appl. No.: 16/916,159

(22) Filed: Jun. 30, 2020

(51) Int. Cl. H02J 7/00

(52) U.S. Cl. CPC H02J 7/0047; H02J 7/0013

(57) ABSTRACT

An intelligent charging equipment includes a main chassis, a plurality of partition plates, a power supply and a control module. When electronic products are of insufficient power, they can be placed into the receiving spaces separately formed by the plurality of partition plates and can be connected to the charging connecting ports inside the receiving spaces in order to perform charging of the electronic products. In addition, the control module can be used to set the power supply mode of the power supply such that when it is charging a plurality of electronic products, the most optimal charging mode can be adjusted and achieved.

### BACKGROUND OF THE INVENTION

### 1. Technical Field

The present invention relates to an intelligent charging equipment, in particular, to a charging equipment structure capable of performing automatic adjustment for the most optimal charging mode.

### 2. Description of Related Art

Consumer electronic products of smartphones or tablet computers have become one of the essential tools used by everyone nowadays, and the services and functions provided by such devices have covered the living and works of everyone. The time of each person spent on the use of smartphones or tablet computers is extremely long, and under such condition, the power consumption of such devices is also relatively fast. Accordingly, regardless whether it is for smartphones or tablet computers, it is necessary to perform charging of such devices daily. A conventional user may have only a few units of smartphones or tablet computers such that simple chargers can be used to complete the charging of such devices. However, for education institutions, administrative agencies or corporates and organizations, due to the large quantity of consumer electronic products held, the so-called charging cabinet is used to perform charging on large quantity of consumer electronic products. Nevertheless, the problem that exists in most of the commonly used charging cabinets is the continuous charging state of consumer electronic products already charged fully, leading to unnecessary waste of power consumption. In addition, it can also cause overcharging of the charger of the carrier, or even causing battery swelling or fire and explosion. Furthermore, the program design is improper for excessive discharge of the batteries such that the battery over discharge occurs, causing reduction of the useful lifetime of batteries, or even causing the abnormal condition of charging failure. Furthermore, the charging priority sequence mode cannot be selected. Moreover, if the charging states of all electronic products are turned on at the same time, the current would be too great, leading to the risks of tripping of the master power and fire. In addition, the power circuits required for a charging cabinet is also expensive. In view of the above, the inventor seeks to overcome the aforementioned drawbacks and to provide improvement to solve the technical problem encountered.

### BRIEF SUMMARY OF THE INVENTION

A primary objective of the present invention is: It is mainly formed by a main chassis, a plurality of partition plates, a power supply and a control module. When an electronic product is of insufficient power, it is placed in a receiving space separately formed by the plurality of partition plates, and it is connected to the charging connecting port in the receiving space in order to charge the electronic product. In addition, the control module is also used to set the power supply mode of the power supply such that during the charging of a plurality of electronic products, the charging mode can be adjusted; wherein the charging mode is: after one of the electronic products is inserted into the intelligent charging equipment, a remaining power level of the electronic product is read and is compared with power levels of other electronic products in the equipment such that one of the electronic products of a lower power level is charged first in priority; thereby assuring any one of the electronic products retrieved by a user during the use of the electronic products has a certain power level available for use; finally, one of the electronic products with a relatively higher power level is charged fully; consequently, the intelligent charging equipment is required to be configured to have a capacity smaller than a capacity for charging the power supplies of all of the electronic products at once in order to perform charging of all of the electronic products intelligently in turns with a relatively smaller power supply, thereby saving an expensive power supply cost and reducing a total operating current in order to prevent risks of power tripping and fire.

### BRIEF DESCRIPTION OF THE SEVERAL VIEWS OF THE DRAWINGS

FIG. 1 is a perspective outer appearance view of the present invention.

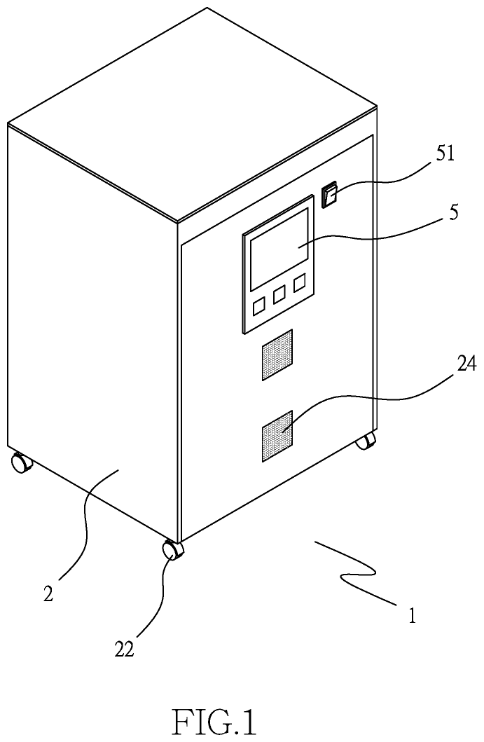

FIG. 2 is an illustration shows a first structural view of the present invention.

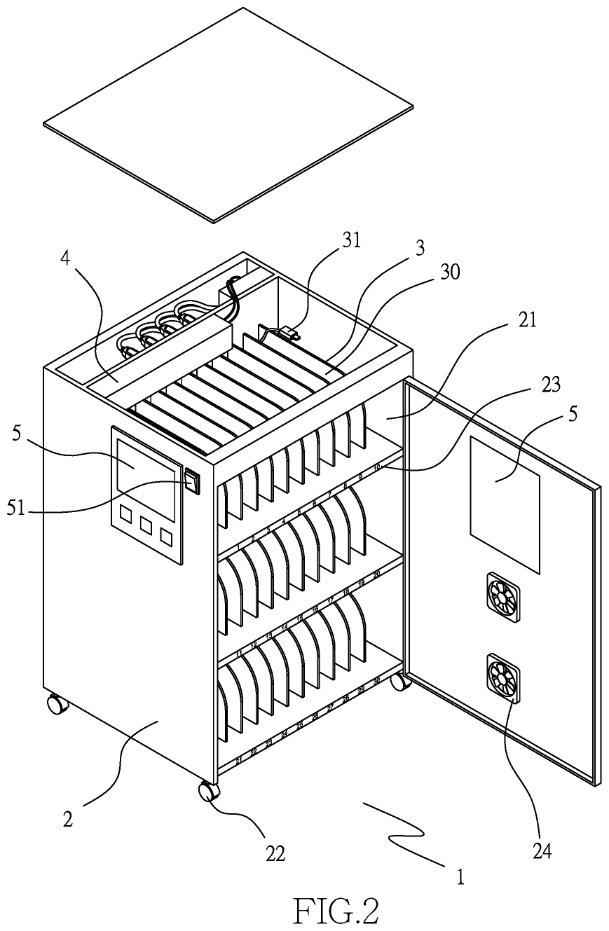

FIG. 3 is an illustration shows a second structural view of the present invention.

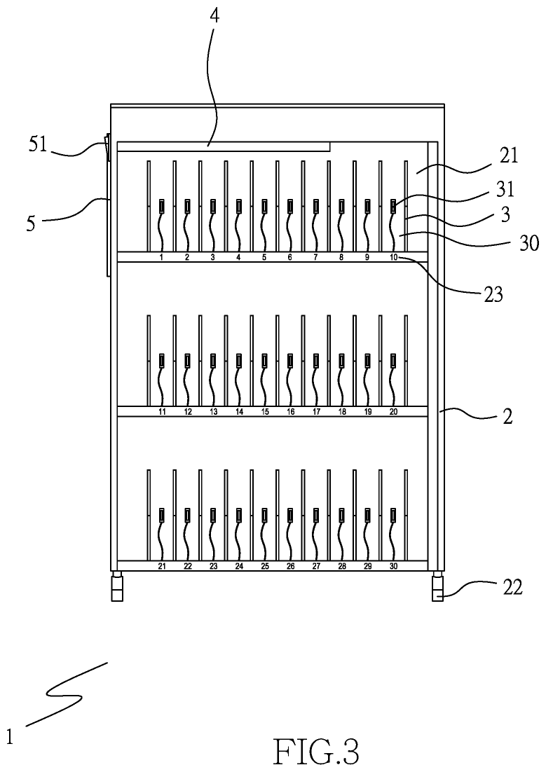

FIG. 4 is an illustration showing a preferred embodiment of the present invention.

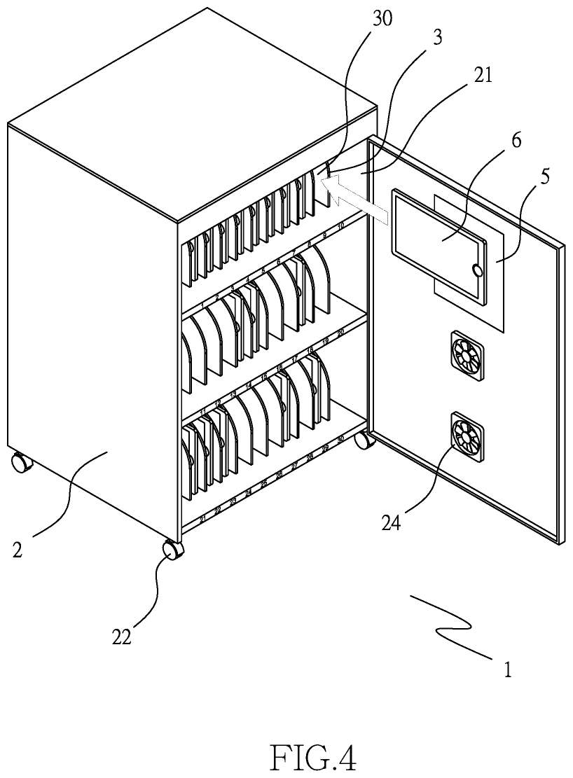

### DETAILED DESCRIPTION OF THE INVENTION

An intelligent charging equipment 1 of the present invention mainly comprises:

a main chassis 2 having a plurality of partition layers 21 arranged therein;

a plurality of partition plates 3 respectively installed inside the partition layers 21 of the main chassis 2 and configured to from a plurality of receiving spaces 30 separated from each other; the receiving spaces 30 having charging connecting ports 31 arranged therein;

a power supply 4 arranged inside the main chassis 2;

a control module 5 arranged on an outer side of the main chassis 2;

wherein a bottom portion of the main chassis 2 further comprises a plurality of rollers 22 in order to facilitate the moving of the intelligent charging equipment 1 for use;

wherein the partition layers 21 of the main chassis 2 further includes a plurality of numbers 23 indicated thereon respectively, and such numbers 23 correspond to the receiving spaces 30 formed separately by the plurality of partition plates 3 respectively;

wherein the main chassis 2 further includes at least one cooling fan 24;

wherein the plurality of partition plates 3 are arranged to space apart from each other in equal distance in order to separately form the receiving spaces 30 having a size equal to each other;

wherein the power supply 4 is electrically connected to the charging connecting port 31;

wherein the control module 5 further comprises a switch 51;

during the use of the equipment, it is mainly to place electronic products 6 with insufficient power inside the receiving spaces 30 separately formed by the plurality of partition plates 3 and connected to the charging connecting ports 31 inside the receiving spaces 30, and the control module 5 is used to activate the power supply 4 to perform charging of the electronic products 6;

wherein the charging mode is: after one of the electronic products 6 is inserted into the intelligent charging equipment 1, a remaining power level of the electronic product 6 is read and is compared with power levels of other electronic products 6 in the intelligent charging equipment 1 such that one of the electronic products of a lower power level is charged first in priority; thereby assuring any one of the electronic products 6 retrieved by a user during the use of the electronic products 6 has a certain power level available for use; finally, one of the electronic products 6 with a relatively higher power level is charged fully. Consequently, the intelligent charging equipment 1 can be configured to have a capacity smaller than a capacity for charging the power supplies 4 of all of the electronic products 6 at once in order to perform charging of all of the electronic products 6 intelligently in turns with a relatively smaller power supply 4, thereby saving an expensive cost of the power supply 4 and reducing a total operating current of the intelligent charging equipment 1 in order to prevent risks of power tripping and fire.

According to the above, when there is a need to charge a plurality of electronic products 6, each one of the electronic products 6 can be sequentially placed into the receiving spaces 30 respectively and can be connected to the charging connecting ports 31 inside the receiving spaces 30. In addition, since each receiving space 30 has a corresponding number 23, the user is able to use the control module 5 to set the charging priority sequence according to the number 23 and to set the stop of further continuous charging when the power level of an electronic product 6 is fully charged or reaches a specific power level.

In addition, since the power supply 4 has limited power supply capacity, if there is a greater number of electronic products 6 for charging or if each receiving space 30 is placed with an electronic product 6, then the user can also use the control module 5 to set a special charging mode, such as setting No. 1 to 10 of the numbers 23 of the receiving spaces 30 to be charged in priority, and No. 11 to 20 of the numbers 23 of the receiving spaces 30 to have the second priority in sequence for charging, and No. 21˜30 of the numbers 23 of the receiving spaces to have the lowest priority in sequence for charging. Furthermore, it can also be set in such a way that when a certain electronic product 6 is fully charged, the power is transmitted to other charging connecting port 31 in order to achieve the most optimal, most effective and most energy-saving charging mode. Alternatively, the control module 5 can also be used to set the action of charging such that the action of charging is only activated at a predefined time.

Furthermore, through the control module 5, it can also display the charging state of each receiving space 30 in order to allow the user to monitor the charging state at any time or to make setting adjustments at any time. The setting method can be configured to provide a setting function for three modes, and the three modes include an in-class mode, a holiday mode and a user-defined setting mode. All of the aforementioned modes can operate in a cycle of seven days per week and allows setting at a time unit of hour. For example, the in-class mode refers to the charging time starting from 5:00 p.m. Monday to Friday to 7:00 a.m. of next morning; the holiday mode refers to the continuous charging time from 7:00 a.m. to 7:00 p.m. of each day; the user-defined setting mode refers to that the charging time can be in a cycle of seven days per week and allowing the setting with a time unit of hour.

In view of the above, in comparison with a known charging cabinet with various drawbacks, the intelligent charging equipment 1 of the present invention is able to utilize the design of the power supply 4 and the control module 5 in order to allow the user to set a charging mode with greatest efficiency, charging priority sequence and most optimal demands during the charging of a plurality of electronic products 6, thereby achieving the objective of completing the power charging under the most energy and time saving condition.

What is claimed is:

1. An intelligent charging equipment, comprising:
a main chassis having a plurality of partition layers arranged therein;
a plurality of partition plates respectively installed inside the partition layers of the main chassis and configured to from a plurality of receiving spaces separated from each other; the receiving spaces having charging connecting ports arranged therein;
a power supply arranged inside the main chassis;
a control module arranged on the main chassis;
configured mainly to place electronic products with insufficient power inside the receiving spaces separately formed by the plurality of partition plates and connected to the charging connecting ports inside the receiving spaces in order to perform charging of the electronic products, and the control module being used to set the power supply mode of the power supply, thereby during charging of the electronic products, a charging mode below being adjusted and achieved:
wherein the charging mode is: after one of the electronic products is inserted into the intelligent charging equipment, a remaining power level of the electronic product is read and is compared with power levels of other electronic products in the equipment such that one of the electronic products of a lower power level is charged first in priority; thereby assuring any one of the electronic products retrieved by a user during the use of the electronic products has a certain power level available for use; finally, one of the electronic products with a relatively higher power level is charged fully; consequently, the intelligent charging equipment is required to be configured to have a capacity smaller than a capacity for charging the power supplies of all of the electronic products at once in order to perform charging of all of the electronic products intelligently in turns with a relatively smaller power supply, thereby saving an expensive power supply cost and reducing a total operating current of the equipment in order to prevent risks of power tripping and fire.

2. The intelligent charging equipment according to claim 1, wherein a bottom portion of the main chassis further comprises a plurality of rollers.

3. The intelligent charging equipment according to claim 1, wherein the partition layers of the main chassis further includes a plurality of numbers indicated thereon respectively, and the numbers correspond to the receiving spaces formed separately by the plurality of partition plates respectively.

4. The intelligent charging equipment according to claim 1, wherein the main chassis further includes at least one cooling fan.

5. The intelligent charging equipment according to claim 1, wherein the plurality of partition plates are arranged to space apart from each other in equal distance in order to separately form the receiving spaces having a size equal to each other.

6. The intelligent charging equipment according to claim 1, wherein the power supply is electrically connected to the charging connecting port.

7. The intelligent charging equipment according to claim 1, wherein the control module further comprises a switch.

8. The intelligent charging equipment according to claim 1, wherein the user uses the control module to set a charging priority sequence according to the numbers and to set a stop for continuous charging of the electronic product when the power is charged fully or when a certain power level is reached.

9. The intelligent charging equipment according to claim 1, wherein the control module is configured to display a charging state of each one of the receiving spaces, thereby allowing the user to monitor the charging state at any time or to make a setting adjustment at any time.

10. The intelligent charging equipment according to claim 1, wherein the control module is configured to provide a setting function for three modes, and the three modes include an in-class mode, a holiday mode and a user-defined setting mode; each one of the three modes operates in a cycle of seven days per week and allows setting at a time unit of hour.
